(19) United States
(12) Patent Application Publication
(10) Pub. No.: US 2020/0014142 A1
(43) Pub. Date: Jan. 9, 2020

(54) Tough flexible resistant pouch with sealable sides used to protect the plugs and sockets of electric cords or other types of connections from the elements

(71) Applicant: Brian Linville Fisher, Las Vegas, NV (US)

(72) Inventor: Brian Linville Fisher, Las Vegas, NV (US)

(21) Appl. No.: 16/027,070

(22) Filed: Jul. 3, 2018

(51) Int. Cl. H01R 13/52; B65D 65/42

(52) U.S. Cl. CPC H01R 13/5213; H01R 13/639; B65D 65/42

(57) ABSTRACT

The invention is a seal-able polymeric pouch designed to protect the connections of Electric Cords, Phone Cords, Ropes, Tubing, etc. from wet or dirty environmental conditions. Previous products protect one electrical connection at a time, are inflexible, don't allow customization, do not easily attach to other objects or be suspended off of the ground, and are hard to find in the dark, or areas with limited visibility. The invention here protects from the environment by becoming a tightly sealed pouch around the cords, is made of flexible polymeric material that can be colored in any pattern desired to customize the invention. The invention can be easily attached or suspended as needed and have location devices combined with it for easier location.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING

Not Applicable.

### BACKGROUND OF THE INVENTION

The invention came about because there are very few products that provide flexibility of application while protecting the mating plug and socket of Electric Cords, Phone Cords, Ropes, Tubing, etc. from environmental conditions. While there are some products available for protection from the environment they all have their short comings.

The most common problem of previous products is that they ONLY allow for the protection of one (1) electrical plug at a time. In many instances, this is acceptable, however, there are a large number of instances where more than one electric cord or other connection needs to be made at a time.

Another issue is their inflexible nature, even though these items often are used in tight or abnormally shaped spaces, and flexibility is required.

Another issue is that the material these products are made from provide no ability to color customize them, you basically get one choice of color; while often a choice between clear, colored or even a personalized option is desired.

While some of the previous products can be attached to other objects most of them cannot, and even these products cannot be suspended off of the ground; this invention can not only be hung off the ground or attached to other objects, but can even be staked firmly down, to fix them it the ground or other objects.

A last problem with previous products is that they can be hard to find in the dark, or if used in an area with limited visibility or debris that ends up covering them.

### BRIEF SUMMARY OF THE INVENTION

Electrical cords, extension cords, phone cords, rope and other tubing are commonly used in homes, industrial facilities, outdoor construction sites, manufacturing plants, campgrounds, etc. Often the mating plug and socket ends of these items are simply connected together and allowed to lie on the ground, where they are exposed to water, dirt, and other contaminants. If moisture and/or contaminants are allowed to contaminate the connections and ends of these items, not only can they cause these items to not work properly, but electrical shortage could occur causing damage to property and/or harm to people and animals.

Using tough, flexible material (polymeric, plastic, vinyl, plastic sheeting, Mylar, etc) to create a pouch that has flaps to allow it to wrap around and seal the cords, ropes, tubing, etc; the invention is a practical way of protecting these items from the elements. The invention is made using thick enough plastic, vinyl, or other tough, flexible sheeting to provide protection from the environment. A larger backing sheet having “flaps” (which are contoured to tightly wrap around the cords, ropes, tubing, etc, providing an element-resistant seal), is overlaid with a smaller fronting sheet. The flaps are coated with an adhesive material to create the seal, although the use of “Velcro-like”, “Zip-lock like”, and folding-lock closures could also be used. The Backing and Fronting sheets are attached by being made in one continuous sheet, or are glued or fused together, making a water-tight seal along the permanently attached edges.

By using multiple “adhesive-coated flaps”, it is possible to have multiple cords, ropes, tubing, etc, attached to each other, allow for these items to enter and exit the pouch individually or severally, and still allow for an environmentally-resistant seal. While the number of flaps and entry/exit points could potentially be unlimited; the use of one, two, or three flaps allowing for two, three, or four entry/exit points makes the most sense for providing flexible options without over-complicating the invention.

Tough, flexible materials such as plastic sheet, vinyl sheeting, etc, gives the invention a wider range of usefulness as well. Previous inventions made to protect electric cord plugs were made of rigid plastic which do not allow you to flex them or place them in smaller areas. The pouch can also be bent, fold or molded around objects, allowing the invention to be used in tight or abnormally shaped places previous inventions could not.

Using Vinyl, plastic or other sheeting material also allows for the invention to be clear, colored, patterned, printed or a mixture of these decorative options. Previous Products are available in only one or two colors, which may not be aesthetically pleasing to users (such as “Bright Orange”).

While the invention can be made without providing for attachment to other objects, the permanently attached areas of the invention can also be “fused” in a wide area, and even reinforced, then holes, grommets, or attachment points and materials (strings, wire, etc) can be added, allowing the invention to be firmly attached to anchors or other objects. Attaching the invention to other objects will prevent the cords, ropes, tubing, etc, from being moved from their desired placement, prevent the plugs from coming apart, and allow the invention to be suspended above the ground keeping the cords and plugs out of water, snow, dirt, mud, etc.

A further advantage this invention has over previous inventions is that, by being flexible one can attach cords, etc. of different sizes and shapes. For example, today there are many times where an electrical cord will be connected by an adapter to an USB cable (phone charger's, etc) which is an entirely different size and sometimes shape. With previous inventions this type of connection would not be able to be protected as the cable sizes are so completely different. However, with the flexible nature of the flaps and adhesive of this invention, there is no end to the possible connections which could be protected.

Other options available for the invention will allow for it to be found in the dark, or in areas with limited visibility or debris that may accumulate around the invention. By making additional pouches in the invention, you can add lights or sound makers to the invention. These pouches could be fused closed or left open, depending upon the desire to have this as a one-time use or re-usable function. While being produced, or as an after-market addition, a light (permanent or remote controlled), glow stick (permanent or remote controlled), beeper (permanent or remote controlled), siren (permanent or remote controlled), etc, could be placed within the body of the invention. The light, glow stick, beeper, siren, etc, will either be used to continually locate the invention, or used only when the invention needs to be located and is activated.

### BRIEF DESCRIPTION OF THE SEVERAL VIEW OF THE DRAWING

Page 1 contains FIGS. 1-4 show the invention as made for protecting one (1) electrical connection or two (2) cords.

Page 2 contains FIGS. 5-8 show the invention as made for protecting two (2) electrical connections or three (3) cords.

Page 3 contains FIGS. 9-12 show the invention as made for protecting three (3) electrical connections or four (4) cords.

Page 4 contains FIGS. 13-16 show the invention as made for protecting one (1) electrical connection or two (2) cords, with a “Location Device” placed either in a secondary pouch, or fused within the invention.

FIG. 1 shows the Front Panel (“A”) of the invention, which can be of any size, as long as it will cover the mating plug and socket of the electrical cord, or other connected item.

FIG. 2 shows the Back Panel (“B”) of the invention, which can be of any size as long as it is larger than “A” in by at least ¼ inch in one dimension and will cover the mating plug and socket of the electrical cord, or other connected item.

FIG. 3 shows “A” overlaying “B” with the edges sealed and the bottom sealed in a wider margin, with holes in it to provide for securing the invention.

FIG. 4 shows how the invention works, with the flap (“F”) folded over to create a seal around two connected electrical cords.

FIG. 5 shows the Front Panel “A” of the invention, which can be of any size, as long as it will cover the mating plug and socket of the electrical cord, or other connected item.

FIG. 6 shows the Back Panel “B” of the invention, which can be of any size as long as it is larger than “A” in by at least ¼ inch in two dimensions and will cover the mating plugs and sockets of the electrical cords, or other connected items.

FIG. 7 shows “A” overlaying “B” with one edge sealed and the bottom sealed in a wider margin, with holes in it to provide for securing the invention.

FIG. 8 shows how the invention works, with the flaps “F” folded over to create seals around three connected electrical cords.

FIG. 9 shows the Front Panel “A” of the invention, which can be of any size, as long as it will cover the mating plug and socket of the electrical cord, or other connected item.

FIG. 10 shows the Back Panel “B” of the invention, which can be of any size as long as it is larger than “A” in by at least ¼ inch in three dimensions and will cover the mating plugs and sockets of the electrical cords, or other connected items.

FIG. 11 shows “A” overlaying “B” with the bottom sealed in a wider margin, with holes in it to provide for securing the invention.

FIG. 12 shows how the invention works, with the flaps “F” folded over to create seals around four connected electrical cords.

FIG. 13 shows a “Location Device” which can be used to aid in locating the invention.

FIG. 14 shows a “Location Device” which has been placed in a secondary pouch made by fusing a line inside the primary pouch of the invention. This fused line could also be curved, partially fused, etc, as desired.

FIG. 15 shows a “Location Device” which has been placed in a secondary pouch made by fusing a line outside the primary pouch of the invention. This fused line could also be curved, partially fused, etc, as desired.

FIG. 16 shows a “Location Device” which has been placed within the fused bottom edge of the invention. This fused line could also be curved, partially fused, etc, as desired.

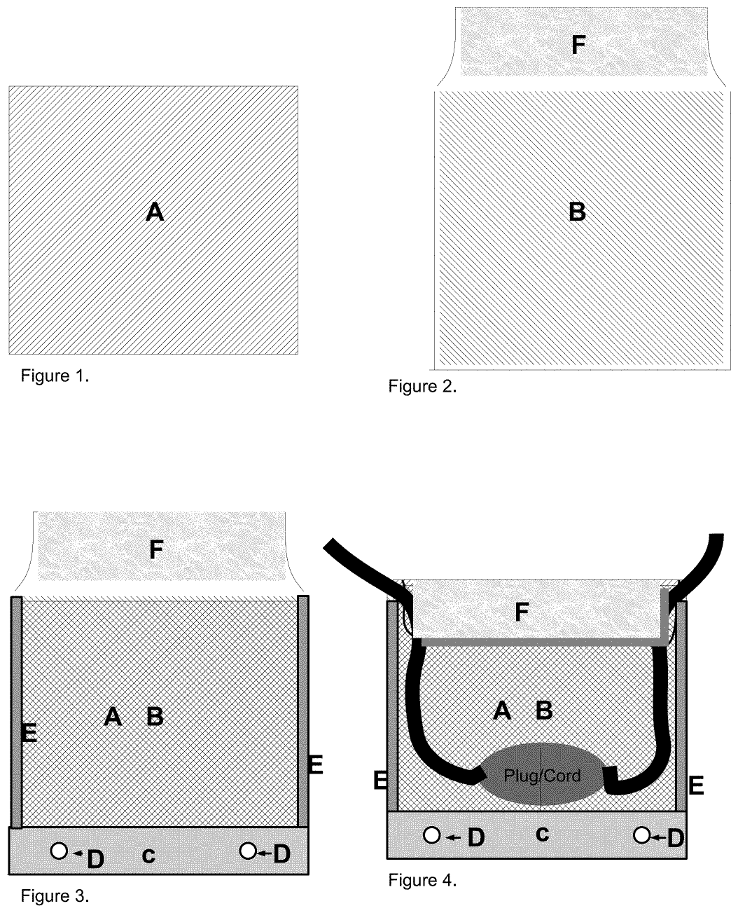

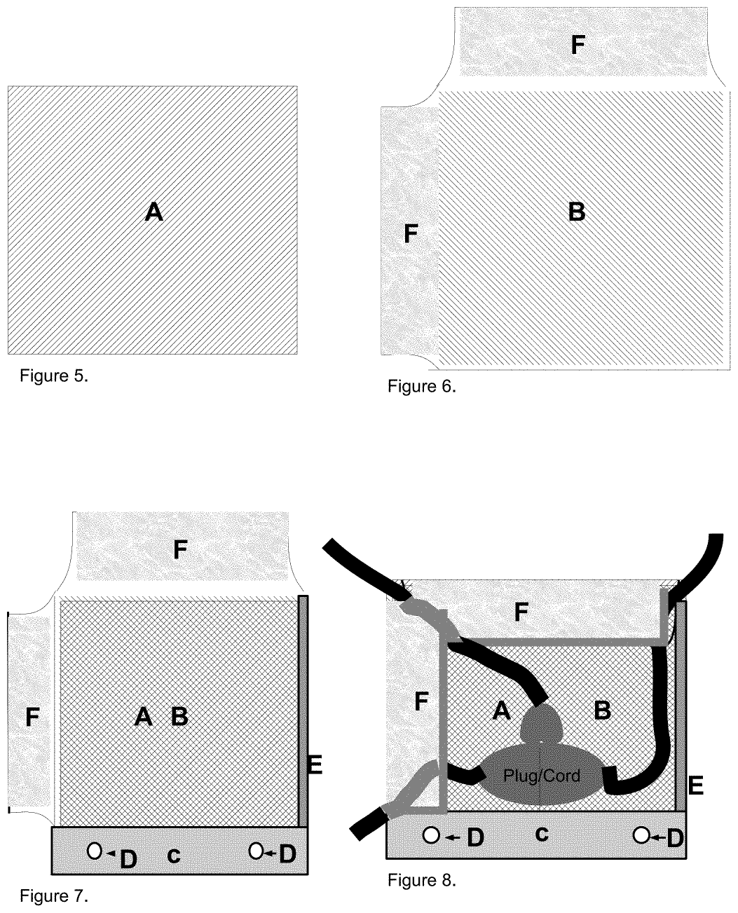

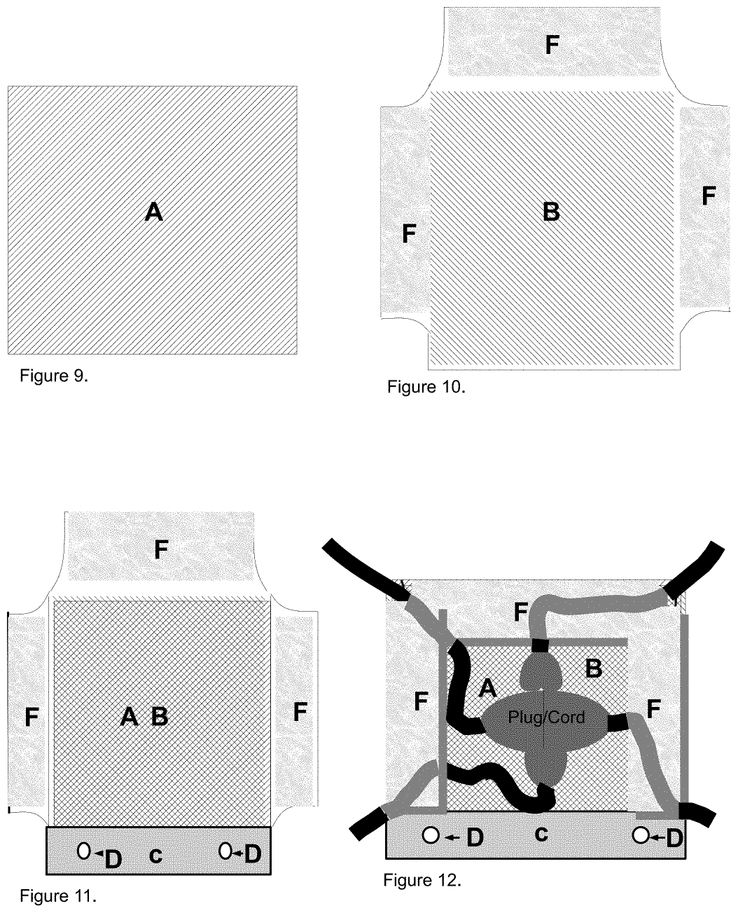

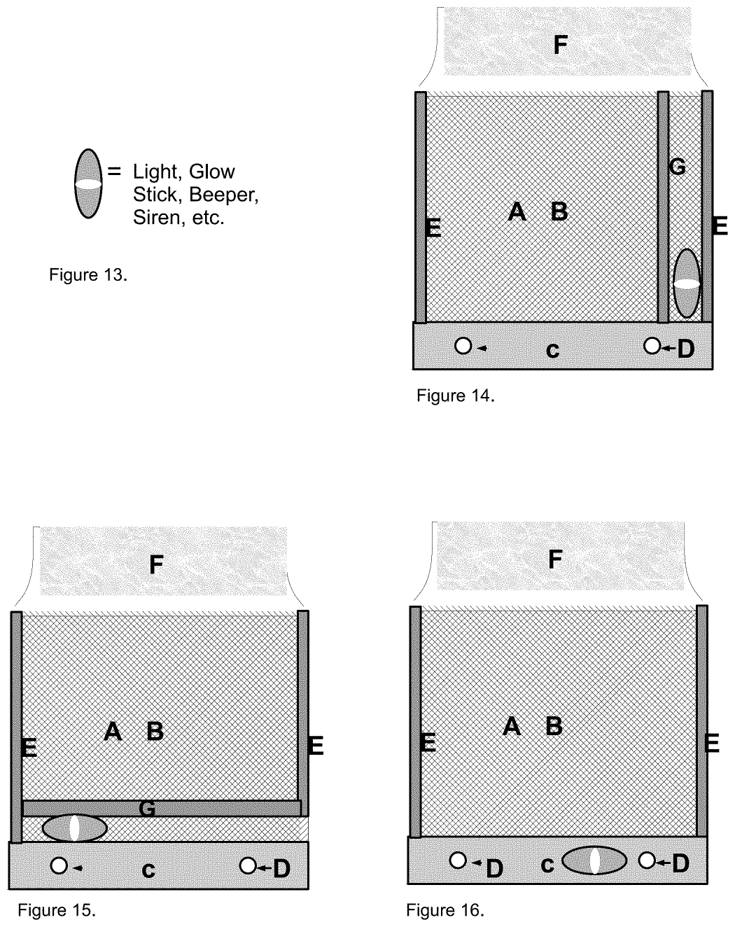

### DETAILED DESCRIPTION OF THE INVENTION

The invention is, or becomes, a “pouch” made of tough, environmentally-resistant, flexible material (polymeric, plastic, vinyl, plastic sheeting, etc), which has the ability to be tightly sealed around an electrical cord, tube, rope, or other item to protect the item and any connections contained within the invention from the environment.

While many ways have been created to “close” plastic bags, pouches, sacks and coverings, this invention is unique in that the self-sealing, flexible flaps allow it to wrap around items (such as cords, ropes, tubing, etc) as a practical way of protecting these items from the elements. The invention in its most useful form is made using thick enough polymeric, plastic, vinyl, or other tough, flexible, impervious sheeting to provide protection from moisture, dirt, dust, animals and insects in environment; although the invention could also be made from textiles or even non-flexible, or permeable materials, these would defeat the advantages of the invention.

By starting as a pouch, or by being made to where the “side(s)” and/or “top” flaps of the invention can be folded over to make it into a pouch, the invention is more flexible in its form and application(s) than previous inventions which are made of hard plastics and therefore not adjustable to use for different sizes and shapes of materials to be protected.

The invention is made the same way that “plastic bags” are made, with only a few minor adjustment's. The most common process for making plastic bags is similar across manufacturers, although some may add proprietary steps or use specialized equipment. Typically, there are two steps in making a basic plastic bag, though some bags may receive additional processing; step 1 is the Extrusion Process and step 2 is Converting the Film to Bags. The invention can be made by performing both steps, or more simply by buying readily available Polymer film, and then converting the film into the invention. Personalization and decoration of the Invention can be done by buying pre-colored film, or by printing the plastic before or after the conversion step.

Typically the extrusion process consists of taking pellets of the material to be used (Vinyl, plastic, etc) and heating them to melt the pellets. The melted material is moved through an extruder that forces the molten “plastic” to where it can be pushed through a “die” to control the thickness of the product. Air then forces the emerging plastic film into a bubble, or the desired shape, and it is then put through a cooling process while any remaining air is removed, and the material is then flattened into a film which is cut to size and wrapped on a spindle.

The “bags” are created by then converting the film into the bag. The roll of film is unrolled and sliced with a heated knife that both seals the sides of the bag and cuts it to size. At this time, they add any special characteristics needed for the completed bag. Dies can cut out handles, wheels produce gussets, and zippered seals or other closures are attached with heat or by ultrasonic means. Any printing may be done after the bags have been converted, or between the extrusion and conversion processes.

In creating the invention, the film is unrolled and the heated knife is used to cut and seal the plastic so that the backing sheet is larger than the front producing “flaps” (the flaps can be straight or contoured) that will be used to tightly wrap around the cords, ropes, tubing, etc. The size and shape of the invention and the “flaps” can vary greatly (square, rectangle, round, polygonal, small to large as desired), but both sheets need to be large enough that when the are folded over and attached to the front sheet they will provide enough room for the plugs and for an element-resistant seal.

While the number of “flaps” and entry/exit points could potentially be unlimited; the use of one, two, or three flaps allowing for two, three, or four entry/exit points makes the most sense for providing flexible options without over-complicating the invention, thus those would be the patterns used in creating the invention. By using a squared or rectangular pattern, the invention will allow for adequate flexibility in design and use.

After the pieces are cut to the proper size and shape, you can use either the heat or ultrasonic method to fuse any sides as needed, and the bottom of the invention is then fused together in a larger area where reinforced “holes” are made (for securing the invention to objects, etc). The sides and bottom of the invention could be pleated, or otherwise deepened to allow for increased volume inside the pouch, however, it is deemed that by fusing the edges flat together the flaps would be better able to create an environmentally protective seal around the cords. The size and shape of the fused are of this flap can be varied as desired, but the desired would be a rectangle about 1″ wide, or a size and shape which is large enough that making and using the holes will not interfere with the integrity of the weather-resistance of the pouch that is created. In some applications, any desired grommets, strings, wise, etc, would be added to the holes for more strength or options.

The material for making the invention will typically start out clear, and can be used in this state, although, you could use pre-colored material, or the film could be colored or printed before cutting and fusion, or it may be printed on after it is cut and fused, thus allowing for the invention to be clear, white, any color, any patterned, have printed symbols, names, or any desired designs as well. Because of the available computerized printing programs, and available printers and technology, the options for decorations are virtually unlimited, even including 3-D customization. Additionally, the invention could be made with a material such as Mylar, which would provide for a reflective surface.

In producing this invention, the final step in the process with be to coat the “flaps” with an adhesive material (such as the starch, dextrin or gum arabic glues used on envelopes; however, we need to use a water-repellent adhesive, such as an acrylate or epoxy glue, otherwise, the environmental resistance of the invention is compromised. In the case of the invention a synthetic rubber adhesive will be applied to the interior of the flap, and covered with a pressure-sensitive acrylate adhesive, supplied on a paper or plastic liner (such as the adhesive and paper cover used for Breathe Right Nasal Strips) which is removed to expose the adhesive which will be used to create the seal when the flap is folded over and pressed onto the ‘front’ of the invention. Although earlier manifestations of the invention looked at the use of “Velcro-like”, “Zip-lock like”, and folding-lock closures, these were deemed to be less than desirable as they were not as environmentally resistant as adhesive.

Optionally, the flap(s) of the invention can be processed so that there is a “micro-perforated” line or an embedded “tear-strip” running from side to side, allowing the invention to be removed easily for disposal.

Other options available for the invention will combining the invention with a “Location Device,” which will allow for it to be found in the dark, or in areas with limited visibility or debris that may accumulate around the invention. By making additional pouches in the invention, you can add lights or sound makers to the invention. These pouches could be fused closed or left open, depending upon the desire to have this as a one-time use or re-usable function. While being produced, or as an after-market addition, a light (permanent or remote controlled), glow stick (permanent or remote controlled), beeper (permanent or remote controlled), siren (permanent or remote controlled), etc, could be placed within the body of the invention. The light, glow stick, beeper, siren, etc, will either be used to continually locate the invention, or used only when the invention needs to be located and is activated by using a remote control for the ‘location device’.

The use of the invention is very simple, the only differences being whether the particular manifestation of the invention uses one, two or three flaps.

In a single flap manifestation of the invention (one flap used for connecting two electric cords, etc), the first step is to connect (“plug in” the mating plug and socket of) the electrical cords (or phone cords, ropes, etc) together securely.

Second, the connection area of the cords is placed through the ‘top’ opening of the invention, inside the pouch of the invention (created by the fusion of the ‘bottom’ and ‘sides’ of “A” with “B”), with one cord exiting through the top left-side opening of the invention, and the other cord exiting through the top right-side opening of the invention.

Third, the plastic or paper strip protecting the adhesive on the flap “F” is then removed.

Fourth, the flap of the invention is carefully folded so that it wraps snugly around both of the cords, and then the flap is laid flat over the front sheet “A” of the invention and pressed firmly in place so the adhesive makes a tight seal.

Finally, the invention is secured if desired, using nails, screws, tent stakes, wire, string, etc, placed through the holes “D” in the reinforced ‘bottom’ “C” of the invention.

When finished with use, the adhesive on the flap is gently peeled back if it is to be re-used, or the flap is torn off using the micro-perforations or tear strip if not to be re-used. The electrical cords, etc. are then removed.

In a multiple flap manifestation of the invention (ie—two or three flaps used for three or four cords, etc), the first step is to connect (“plug in” the mating plugs and sockets of) the electrical cords (or phone cords, ropes, etc) together securely.

Second, the connection area of the cords is placed through the ‘top’ and ‘side’ openings of the invention, inside the pouch of the invention (created by the fusion of the ‘bottom’, and ‘side’ if appropriate, of “A” with “B”), with each cord exiting through one corner opening of the invention.

Third, the plastic or paper strip protecting the adhesive on one of the flaps “F” is then removed.

Fourth, the flap of the invention is carefully folded so that it wraps snugly around the two cords it is to protect, and then the flap is laid flat over the front sheet “A” of the invention and pressed firmly in place so the adhesive makes a tight seal.

The third and fourth steps are then repeated for each flap, with adjacent flaps overlying the neighboring flap, until the pouch is fully sealed.

Finally, the invention is secured if desired, using nails, screws, tent stakes, wire, string, etc, placed through the holes “D” in the reinforced ‘bottom’ “C” of the invention.

When finished with use, the adhesive on the flap is gently peeled back if it is to be re-used, or the flap is torn off using the micro-perforations or tear strip if not to be re-used. The electrical cords, etc. are then removed.

I claim:

1. A polymeric bag including:
a. a pair of superimposed sheet portions, the corresponding edges of which are bended together to form scaled skies and leaving an open side,
b. where one of the sheet portions is made so that where the open side is this sheet is longer than the other sheet portion forming a “flap”,
c. where the size of the ‘flap’ is large enough to allow the side edges to wrap around one or more (electrical) cords and still fold over and cover the top portion of the other sheet,
d. the interior surface of the ‘flap’ is coated with a water-proof adhesive which allow the ‘flap’ to be folded over on to the other sheet portion and create a weather resistant seal to the bag.

2. The plastic bag as defined in claim 1, wherein there are two or more open sides, each corresponding to a longer ‘flap’ of one of the sheet portions, so that two or more “flaps” can be folded over to create a weather resistant seal to the bag.

3. The plastic bag as defined in claim 1 or 2, where the ‘flap(s)’ is/are contoured to tightly wrap around multiple “cord's” while being sealed, thus creating a weather-resistant seal around the ‘cord's’, while protecting the connections inside the bag, or the part of the cord inside the bag.

4. The plastic bag as defined in claim 1 or 2, wherein the ‘flap(s)’ use(s) non-water proof adhesives, allowing for the ‘flap(s)’ to be removed easily, or reused.

5. The plastic bag as defined in claim 1 or 2, wherein the ‘flap(s)’ has/have micro-perforations which allow for the ‘flap(s)’ to be torn open to allow for quick opening of the bag.

6. The plastic bag as defined in claim 1 or 2, wherein the ‘flap(s)’ has/have a “tear strip” to allow for the ‘flap(s)’ to be torn open to allow for quick opening of the bag.

7. The plastic bag as defined in claim 1 or 2, wherein the ‘flap(s)’ use(s) velcro, zip lock, folding-lock, snaps, or other non-weather resistant closures.

8. The plastic bag as defined in claim 1 or 2, wherein the ‘bottom’ and/or ‘sides’ of the bag is/are sealed in such a way that it/they create(s a) reinforced large flattened surface(s).

9. The plastic bag as defined in claim 1 or 2, wherein the ‘bottom’ and/or ‘sides’ of the bag is seated in such a way that it/they create(s a) reinforced large flattened surface(s) which has/have holes in them to allow for tying or staking of the bag to another object.

10. The plastic bag as defined in claim 1 or 2, wherein the ‘bottom’ and/or ‘sides’ of the bag is sealed in such a way that it/they create(s a) reinforced large flattened surface(s) which has/have plastic ties extending from them to allow for tying the bag to another object.

11. The plastic bag as defined in claim 1 or 2, wherein the ‘bottom’ and/or ‘sides’ of the bag is sealed in such a way that it/they create(s) a) reinforced large flattened surface(s) which has/have plastic ties extending from them to allow for tying the bag to another object.

12. The plastic bag as defined in claim 1 or 2, wherein there is an extra line of fusion within the primary pouch, allowing for the insertion of a “Location Device” within the invention and covered by the flap.

13. The plastic bag as defined in claim 1 or 2, wherein there is an extra line of fusion outside of the primary pouch, allowing for the insertion of a “Location Device” within the invention, and covered by the flap.

14. The plastic bag as defined in claim 1 or 2, wherein there is a “Location Device” embedded within the invention.
